(19) United States
(12) Patent Application Publication
(10) Pub. No.: US 2012/0185867 A1
(43) Pub. Date: Jul. 19, 2012

(54) Optimizing The Deployment Of A Workload On A Distributed Processing System

(75) Inventors: Charles J. Archer, Rochester, MN (US); Mark G. Megerian, Rochester, MN (US); Gary R. Ricard, Chatfield, MN (US); Brian E. Smith, Rochester, MN (US)

(73) Assignee: INTERNATIONAL BUSINESS MACHINES CORPORATION, ARMONK, NY (US)

(21) Appl. No.: 13/007,905

(22) Filed: Jan. 17, 2011

(51) Int. Cl. G06F 9/46

(52) U.S. Cl. 718/105

(57) ABSTRACT

Optimizing the deployment of a workload on a distributed processing system, the distributed processing system having a plurality of nodes, each node having a plurality of attributes, including: profiling during operations on the distributed processing system attributes of the nodes of the distributed processing system; selecting a workload for deployment on a subset of the nodes of the distributed processing system; determining specific resource requirements for the workload to be deployed; determining a required geometry of the nodes to run the workload; selecting a set of nodes having attributes that meet the specific resource requirements and arranged to meet the required geometry; deploying the workload on the selected nodes.

### STATEMENT REGARDING FEDERALLY SPONSORED RESEARCH OR DEVELOPMENT

This invention was made with Government support under Contract No. B554331 awarded by the Department of Energy. The Government has certain rights in this invention.

### BACKGROUND OF THE INVENTION

1. Field of the Invention

The field of the invention is data processing, or, more specifically, methods, apparatus, and products for optimizing the deployment of a workload on a distributed processing system.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Next generation supercomputers and distributed compute platforms contain many execution nodes, many of which have different components and different processing capabilities. As such, one execution node may be able to execute particular workloads in a more efficient manner than another execution node because of the differences between the two execution nodes. Computing workloads may therefore be more efficiently executed by scheduling and assigning the workloads in a way to better utilize the resources in a particular system.

### SUMMARY OF THE INVENTION

Methods, apparatus, and products for optimizing the deployment of a workload on a distributed processing system, the distributed processing system having a plurality of nodes, each node having a plurality of attributes, including: profiling during operations on the distributed processing system attributes of the nodes of the distributed processing system; selecting a workload for deployment on a subset of the nodes of the distributed processing system; determining specific resource requirements for the workload to be deployed; determining a required geometry of the nodes to run the workload; selecting a set of nodes having attributes that meet the specific resource requirements and arranged to meet the required geometry; and deploying the workload on the selected nodes.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth example apparatus for optimizing the deployment of a workload on a distributed processing system according to embodiments of the present invention.

FIG. 2 sets forth a block diagram of an example compute node useful in a parallel computer capable of optimizing the deployment of a workload on a distributed processing system according to embodiments of the present invention.

FIG. 3A sets forth a block diagram of an example Point-To-Point Adapter useful in optimizing the deployment of a workload on a distributed processing system according to embodiments of the present invention.

FIG. 3B sets forth a block diagram of an example Global Combining Network Adapter useful in optimizing the deployment of a workload on a distributed processing system according to embodiments of the present invention.

FIG. 4 sets forth a line drawing illustrating an example data communications network optimized for optimizing the deployment of a workload on a distributed processing system according to embodiments of the present invention.

FIG. 5 sets forth a line drawing illustrating an example global combining network useful in systems capable of optimizing the deployment of a workload on a distributed processing system according to embodiments of the present invention.

FIG. 6 sets forth a flow chart illustrating an exemplary method for optimizing the deployment of a workload on a distributed processing system according to embodiments of the present invention.

FIG. 7 sets forth a flow chart illustrating an exemplary method for optimizing the deployment of a workload on a distributed processing system according to embodiments of the present invention.

FIG. 8 sets forth a flow chart illustrating an exemplary method for optimizing the deployment of a workload on a distributed processing system according to embodiments of the present invention.

FIG. 9 sets forth a flow chart illustrating an exemplary method for optimizing the deployment of a workload on a distributed processing system according to embodiments of the present invention.

### DETAILED DESCRIPTION OF EXEMPLARY EMBODIMENTS

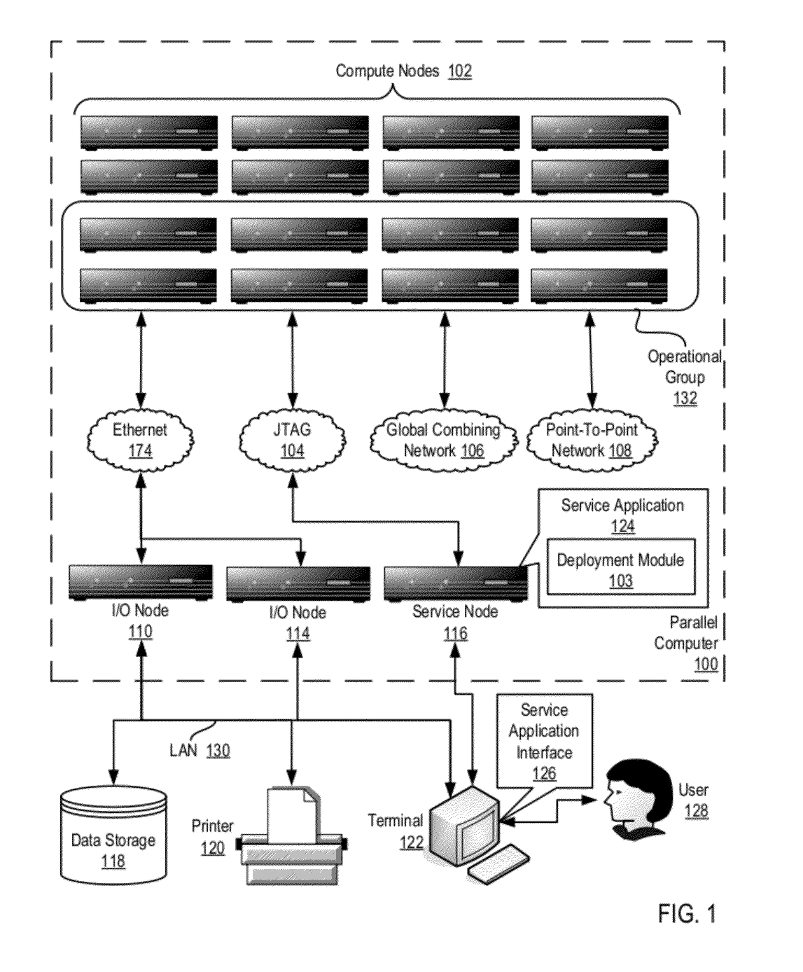

Exemplary methods, apparatus, and products for optimizing the deployment of a workload on a distributed processing system in accordance with the present invention are described with reference to the accompanying drawings, beginning with FIG. 1. FIG. 1 sets forth example apparatus for optimizing the deployment of a workload on a distributed processing system according to embodiments of the present invention. The apparatus of FIG. 1 includes a parallel computer (100), non-volatile memory for the computer in the form of a data storage device (118), an output device for the computer in the form of a printer (120), and an input/output device for the computer in the form of a computer terminal (122). The parallel computer (100) in the example of FIG. 1 includes a plurality of compute nodes (102). The compute nodes (102) are coupled for data communications by several independent data communications networks including a high speed Ethernet network (174), a Joint Test Action Group ('JTAG') network (104), a global combining network (106) which is optimized for collective operations using a binary tree network topology, and a point-to-point network (108), which is optimized for point-to-point operations using a torus network topology. The global combining network (106) is a data communications network that includes data communications links connected to the compute nodes (102) so as to organize the compute nodes (102) as a binary tree. Each data communications network is implemented with data communications links among the compute nodes (102). The data communications links provide data communications for parallel operations among the compute nodes (102) of the parallel computer (100).

The compute nodes (102) of the parallel computer (100) are organized into at least one operational group (132) of compute nodes for collective parallel operations on the parallel computer (100). Each operational group (132) of compute nodes is the set of compute nodes upon which a collective parallel operation executes. Each compute node in the operational group (132) is assigned a unique rank that identifies the particular compute node in the operational group (132). Collective operations are implemented with data communications among the compute nodes of a operational group. Collective operations are those functions that involve all the compute nodes of an operational group (132). A collective operation is an operation, a message-passing computer program instruction that is executed simultaneously, that is, at approximately the same time, by all the compute nodes in an operational group (132) of compute nodes. Such an operational group (132) may include all the compute nodes (102) in a parallel computer (100) or a subset all the compute nodes (102). Collective operations are often built around point-to-point operations. A collective operation requires that all processes on all compute nodes within an operational group (132) call the same collective operation with matching arguments. A ‘broadcast’ is an example of a collective operation for moving data among compute nodes of a operational group. A ‘reduce’ operation is an example of a collective operation that executes arithmetic or logical functions on data distributed among the compute nodes of a operational group (132). An operational group (132) may be implemented as, for example, an MPI ‘communicator.’

‘MPI’ refers to ‘Message Passing Interface,’ a prior art parallel communications library, a module of computer program instructions for data communications on parallel computers. Examples of prior-art parallel communications libraries that may be improved for performing an allreduce operation using shared memory according to embodiments of the present invention include MPI and the ‘Parallel Virtual Machine’ (‘PVM’) library. PVM was developed by the University of Tennessee, The Oak Ridge National Laboratory and Emory University. MPI is promulgated by the MPI Forum, an open group with representatives from many organizations that define and maintain the MPI standard. MPI at the time of this writing is a de facto standard for communication among compute nodes running a parallel program on a distributed memory parallel computer. This specification sometimes uses MPI terminology for ease of explanation, although the use of MPI as such is not a requirement or limitation of the present invention.

Some collective operations have a single originating or receiving process running on a particular compute node in an operational group (132). For example, in a ‘broadcast’ collective operation, the process on the compute node that distributes the data to all the other compute nodes is an originating process. In a ‘gather’ operation, for example, the process on the compute node that received all the data from the other compute nodes is a receiving process. The compute node on which such an originating or receiving process runs is referred to as a logical root.

Most collective operations are variations or combinations of four basic operations: broadcast, gather, scatter, and reduce. The interfaces for these collective operations are defined in the MPI standards promulgated by the MPI Forum. Algorithms for executing collective operations, however, are not defined in the MPI standards. In a broadcast operation, all processes specify the same root process, whose buffer contents will be sent. Processes other than the root specify receive buffers. After the operation, all buffers contain the message from the root process.

A scatter operation, like the broadcast operation, is also a one-to-many collective operation. In a scatter operation, the logical root divides data on the root into segments and distributes a different segment to each compute node in the operational group (132). In scatter operation, all processes typically specify the same receive count. The send arguments are only significant to the root process, whose buffer actually contains sendcount*N elements of a given datatype, where N is the number of processes in the given group of compute nodes. The send buffer is divided and dispersed to all processes (including the process on the logical root). Each compute node is assigned a sequential identifier termed a ‘rank.’ After the operation, the root has sent sendcount data elements to each process in increasing rank order. Rank 0 receives the first sendcount data elements from the send buffer. Rank 1 receives the second sendcount data elements from the send buffer, and so on.

A gather operation is a many-to-one collective operation that is a complete reverse of the description of the scatter operation. That is, a gather is a many-to-one collective operation in which elements of a datatype are gathered from the ranked compute nodes into a receive buffer in a root node.

A reduction operation is also a many-to-one collective operation that includes an arithmetic or logical function performed on two data elements. All processes specify the same ‘count’ and the same arithmetic or logical function. After the reduction, all processes have sent count data elements from computer node send buffers to the root process. In a reduction operation, data elements from corresponding send buffer locations are combined pair-wise by arithmetic or logical operations to yield a single corresponding element in the root process' receive buffer. Application specific reduction operations can be defined at runtime. Parallel communications libraries may support predefined operations. MPI, for example, provides the following pre-defined reduction operations:
MPI_MAX maximum
MPI_MIN minimum
MPI_SUM sum
MPI_PROD product
MPI_LAND logical and
MPI_BAND bitwise and
MPI_LOR logical or
MPI_BOR bitwise or
MPI_LXOR logical exclusive or
MPI_BXOR bitwise exclusive or

In addition to compute nodes, the parallel computer (100) includes input/output (‘I/O’) nodes (110, 114) coupled to compute nodes (102) through the global combining network (106). The compute nodes (102) in the parallel computer (100) may be partitioned into processing sets such that each compute node in a processing set is connected for data communications to the same I/O node. Each processing set, therefore, is composed of one I/O node and a subset of compute nodes (102). The ratio between the number of compute nodes to the number of I/O nodes in the entire system typically depends on the hardware configuration for the parallel computer (102). For example, in some configurations, each processing set may be composed of eight compute nodes and one I/O node. In some other configurations, each processing set may be composed of sixty-four compute nodes and one I/O node. Such example are for explanation only, however, and not for limitation. Each I/O node provides I/O services between compute nodes (102) of its processing set and a set of I/O devices. In the example of FIG. 1, the I/O nodes (110, 114) are connected for data communications I/O devices (118, 120, 122) through local area network (‘LAN’) (130) implemented using high-speed Ethernet.

The parallel computer (100) of FIG. 1 also includes a service node (116) coupled to the compute nodes through one of the networks (104). Service node (116) provides services common to pluralities of compute nodes, administering the configuration of compute nodes, loading programs into the compute nodes, starting program execution on the compute nodes, retrieving results of program operations on the computer nodes, and so on. Service node (116) runs a service application (124) and communicates with users (128) through a service application interface (126) that runs on computer terminal (122).

In the example of FIG. 1, the service node (116) includes a deployment module (103) configured to optimize the deployment of a workload on a distributed processing system according to embodiments of the present invention. In the example of FIG. 1, each of the compute nodes (102) in the parallel computer (100) is characterized by a plurality of attributes that describe characteristics of each compute node (102). For example, attributes that describe characteristics of the compute nodes (102) may include, for example, the speed of a CPU on the a particular compute node, the amount of memory on a particular compute node, the location of particular compute node in the parallel computer (100), and other attributes describing the characteristics of components within particular compute node. In addition, a particular compute node may also characterized by a plurality of attributes that describe characteristics of a particular compute node in the sense that the attributes describe performance-related characteristics of a particular compute node such as, for example, the speed at which a particular compute node can execute floating point operations, the speed at which a particular compute node can transmit a message to another compute node, the speed at which a particular compute node can execute various I/O operations, and so on.

In the example of FIG. 1, the deployment module (103) optimizes the deployment of a workload by profiling during operations on the distributed processing system attributes of the nodes of the parallel computer (100). In the example of FIG. 1, profiling attributes of the compute nodes (102) may be carried out, for example, by recording performance metrics of the compute nodes (102). Such performance metrics may be recorded and compiled such that a profile regarding the performance attributes of the compute nodes (102) can be created. For example, performance metrics may be recorded and compiled such that a profile regarding the performance attributes of the compute nodes (102) can be created that details the amount of time a particular compute node took to carry out a floating point operation, the amount of time a particular compute node took to carry out an I/O operation, the amount of time a particular compute node took to carry out a data communications operation, and other performance metrics can be recorded for the purposes of profiling attributes of the compute nodes (102) of the parallel computer (100).

In the example of FIG. 1, the deployment module (103) also optimizes the deployment of a workload by selecting a workload for deployment on a subset of the compute nodes (102) of the parallel computer (100). In the example of FIG. 1, the workload represents a series of computer program instructions that are to be executed. Workloads may be characterized, for example, by the amount of processor cycles that are required to execute the workload, the amount of memory that is required to execute the workload, the amount of a particular type of operations are required to execute the workload, and so on. In the example of FIG. 1, a workload may be selected for deployment on a subset of the compute nodes (102) of the parallel computer (100) based on, for example, a shortest-time-to-completion scheduling algorithm, a first-in-first-out scheduling algorithm, the availability of a particular type of system resource, a priority associated with the workload, and so on.

In the example of FIG. 1, the deployment module (103) also optimizes the deployment of a workload by determining specific resource requirements for the workload to be deployed. In the example of FIG. 1, determining specific resource requirements for the workload to be deployed may be carried out, for example, by examining the computer program instructions that make up the workload. The computer program instructions that make up the workload may be examined to determine, for example, the number of floating point instructions in the workload, the amount of data communications operations in the workload, the amount of I/O operations in the workload, the number of message passing operations in the workload, and so on. Determining specific resource requirements for the workload to be deployed may therefore be carried out by determining the nature and amount of system resources that are needed to execute each of the component parts of the workload.

In the example of FIG. 1, the deployment module (103) also optimizes the deployment of a workload by determining a required geometry of the compute nodes (102) to run the workload. In the example of FIG. 1, a required geometry of the compute nodes (102) to run the workload may be determined, for example, based on the computer program instructions that make up the workload. For example, a particular workload may include a collective operation. In such an example, the collective operation requires that the compute nodes (102) are organized as a tree. The required geometry of the compute nodes (102) to run the workload in such an example is therefore a tree geometry. Alternatively, a particular workload may require a high number of data communications operations such that a geometry of compute nodes (102) in which the compute nodes (102) are within close physical proximity of each other may be preferred so as to avoid data communications between compute nodes (102) over long physical distances.

In the example of FIG. 1, the deployment module (103) also optimizes the deployment of a workload by selecting a set of compute nodes (102) having attributes that meet the specific resource requirements and arranged to meet the required geometry required by a workload. In the example of FIG. 1, selecting a set of compute nodes (102) having attributes that meet the specific resource requirements and arranged to meet the required geometry may be carried out, for example, by comparing the attributes of a particular set of compute nodes (102) to the resource requirements and required geometry for a workload to determine a best match. Determining a best match may include prioritizing specific resource requirements of the workload, determining a score for a candidate set of compute nodes (102), and so on.

In the example of FIG. 1, the deployment module (103) also optimizes the deployment of a workload by deploying the workload on the selected compute nodes (102). In the example of FIG. 1, deploying the workload on the selected compute nodes (102) may be carried out, for example, by sending the workload, or a portion thereof, to an execution queue on the selected compute nodes (102), assigning the workload for execution on processors of the selected compute nodes (102), and so on.

The arrangement of nodes, networks, and I/O devices making up the example apparatus illustrated in FIG. 1 are for explanation only, not for limitation of the present invention. Apparatus capable of optimizing the deployment of a workload on a distributed processing system according to embodiments of the present invention may include additional nodes, networks, devices, and architectures, not shown in FIG. 1, as will occur to those of skill in the art. The parallel computer (100) in the example of FIG. 1 includes sixteen compute nodes (102); parallel computers capable of optimizing the deployment of a workload on a distributed processing system according to embodiments of the present invention sometimes include thousands of compute nodes. In addition to Ethernet (174) and JTAG (104), networks in such data processing systems may support many data communications protocols including for example TCP (Transmission Control Protocol), IP (Internet Protocol), and others as will occur to those of skill in the art. Various embodiments of the present invention may be implemented on a variety of hardware platforms in addition to those illustrated in FIG. 1.

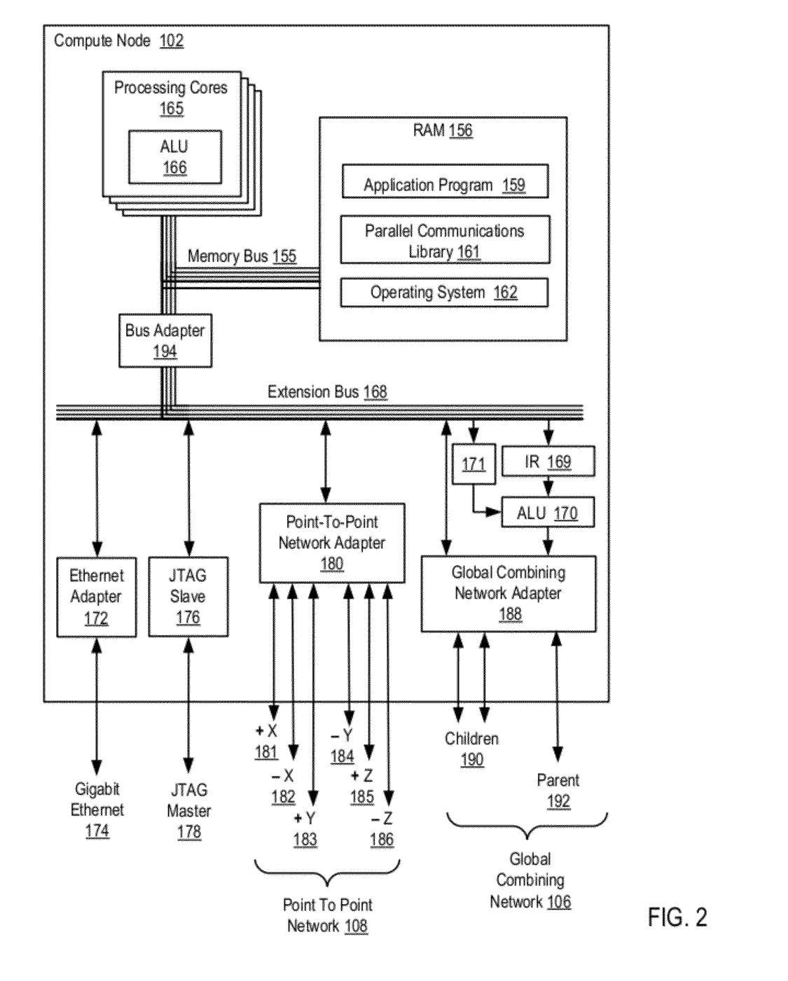

Optimizing the deployment of a workload on a distributed processing system according to embodiments of the present invention is generally implemented on a parallel computer that includes a plurality of compute nodes organized for collective operations through at least one data communications network. In fact, such parallel computers may include thousands of such compute nodes. Each compute node is in turn itself a kind of computer composed of one or more computer processing cores, its own computer memory, and its own input/output adapters. For further explanation, therefore, FIG. 2 sets forth a block diagram of an example compute node (102) useful in a parallel computer capable of optimizing the deployment of a workload on a distributed processing system according to embodiments of the present invention. The compute node (102) of FIG. 2 includes a plurality of processing cores (165) as well as RAM (156). The processing cores (165) of FIG. 2 may be configured on one or more integrated circuit dies. Processing cores (165) are connected to RAM (156) through a high-speed memory bus (155) and through a bus adapter (194) and an extension bus (168) to other components of the compute node.

Stored in RAM (156) is an application program (159), a module of computer program instructions that carries out parallel, user-level data processing using parallel algorithms.

Also stored RAM (156) is a parallel communications library (161), a library of computer program instructions that carry out parallel communications among compute nodes, including point-to-point operations as well as collective operations. Application program (159) executes collective operations by calling software routines in parallel communications library (161). A library of parallel communications routines may be developed from scratch for use in systems according to embodiments of the present invention, using a traditional programming language such as the C programming language, and using traditional programming methods to write parallel communications routines that send and receive data among nodes on two independent data communications networks. Alternatively, existing prior art libraries may be improved to operate according to embodiments of the present invention. Examples of prior-art parallel communications libraries include the ‘Message Passing Interface’ (‘MPI’) library and the ‘Parallel Virtual Machine’ (‘PVM’) library.

Also stored in RAM (156) is a compute node operating system (162), a module of computer program instructions and routines for an application program's access to other resources of the compute node. It is typical for an application program (159) and parallel communications library (161) in a compute node (102) of a parallel computer to run a single thread of execution with no user login and no security issues because the thread is entitled to complete access to all resources of the compute node (102). Operating systems that may usefully be improved, simplified, for use in a compute node include UNIX™, Linux™, Microsoft XP™, AIX™, IBM's i5/OS™, and others as will occur to those of skill in the art. In the example of FIG. 2, the compute node operating system (162) of FIG. 2 may be capable of supporting one or more virtual machines. The compute node operating system (162) of FIG. 2 may therefore include virtual machine management components such as, for example, a hypervisor or other module of automated computing machinery capable of supporting one or more virtual machines.

The example compute node (102) of FIG. 2 includes several communications adapters (172, 176, 180, 188) for implementing data communications with other nodes of a parallel computer. Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in apparatus that page memory from RAM to backing storage in a parallel computer include modems for wired communications, Ethernet (IEEE 802.3) adapters for wired network communications, and 802.11b adapters for wireless network communications.

The data communications adapters in the example of FIG. 2 include a Gigabit Ethernet adapter (172) that couples example compute node (102) for data communications to a Gigabit Ethernet (174). Gigabit Ethernet is a network transmission standard, defined in the IEEE 802.3 standard, that provides a data rate of 1 billion bits per second (one gigabit). Gigabit Ethernet is a variant of Ethernet that operates over multimode fiber optic cable, single mode fiber optic cable, or unshielded twisted pair.

The data communications adapters in the example of FIG. 2 include a JTAG Slave circuit (176) that couples example compute node (102) for data communications to a JTAG Master circuit (178). JTAG is the usual name used for the IEEE 1149.1 standard entitled Standard Test Access Port and Boundary-Scan Architecture for test access ports used for testing printed circuit boards using boundary scan. JTAG is so widely adapted that, at this time, boundary scan is more or less synonymous with JTAG. JTAG is used not only for printed circuit boards, but also for conducting boundary scans of integrated circuits, and is also useful as a mechanism for debugging embedded systems, providing a convenient “back door” into the system. The example compute node of FIG. 2 may be all three of these: It typically includes one or more integrated circuits installed on a printed circuit board and may be implemented as an embedded system having its own processing core, its own memory, and its own I/O capability. JTAG boundary scans through JTAG Slave (176) may efficiently configure processing core registers and memory in compute node (102) for use in dynamically reassigning a connected node to a block of compute nodes for paging memory from RAM to backing storage in a parallel computer according to embodiments of the present invention.

The data communications adapters in the example of FIG. 2 include a Point-To-Point Network Adapter (180) that couples example compute node (102) for data communications to a network (108) that is optimal for point-to-point message passing operations such as, for example, a network configured as a three-dimensional torus or mesh. The Point-To-Point Adapter (180) provides data communications in six directions on three communications axes, x, y, and z, through six bidirectional links: +x (181), −x (182), +y (183), −y (184), +z (185), and −z (186).

The data communications adapters in the example of FIG. 2 include a Global Combining Network Adapter (188) that couples example compute node (102) for data communications to a global combining network (106) that is optimal for collective message passing operations such as, for example, a network configured as a binary tree. The Global Combining Network Adapter (188) provides data communications through three bidirectional links for each global combining network (106) that the Global Combining Network Adapter (188) supports. In the example of FIG. 2, the Global Combining Network Adapter (188) provides data communications through three bidirectional links for global combining network (106): two to children nodes (190) and one to a parent node (192).

The example compute node (102) includes multiple arithmetic logic units (‘ALUs’). Each processing core (165) includes an ALU (166), and a separate ALU (170) is dedicated to the exclusive use of the Global Combining Network Adapter (188) for use in performing the arithmetic and logical functions of reduction operations, including an allreduce operation. Computer program instructions of a reduction routine in a parallel communications library (161) may latch an instruction for an arithmetic or logical function into an instruction register (169). When the arithmetic or logical function of a reduction operation is a ‘sum’ or a ‘logical OR,’ for example, the collective operations adapter (188) may execute the arithmetic or logical operation by use of the ALU (166) in the processing core (165) or, typically much faster, by use of the dedicated ALU (170) using data provided by the nodes (190, 192) on the global combining network (106) and data provided by processing cores (165) on the compute node (102).

Often when performing arithmetic operations in the global combining network adapter (188), however, the global combining network adapter (188) only serves to combine data received from the children nodes (190) and pass the result up the network (106) to the parent node (192). Similarly, the global combining network adapter (188) may only serve to transmit data received from the parent node (192) and pass the data down the network (106) to the children nodes (190). That is, none of the processing cores (165) on the compute node (102) contribute data that alters the output of ALU (170), which is then passed up or down the global combining network (106). Because the ALU (170) typically does not output any data onto the network (106) until the ALU (170) receives input from one of the processing cores (165), a processing core (165) may inject the identity element into the dedicated ALU (170) for the particular arithmetic operation being perform in the ALU (170) in order to prevent alteration of the output of the ALU (170). Injecting the identity element into the ALU, however, often consumes numerous processing cycles. To further enhance performance in such cases, the example compute node (102) includes dedicated hardware (171) for injecting identity elements into the ALU (170) to reduce the amount of processing core resources required to prevent alteration of the ALU output. The dedicated hardware (171) injects an identity element that corresponds to the particular arithmetic operation performed by the ALU. For example, when the global combining network adapter (188) performs a bitwise OR on the data received from the children nodes (190), dedicated hardware (171) may inject zeros into the ALU (170) to improve performance throughout the global combining network (106).

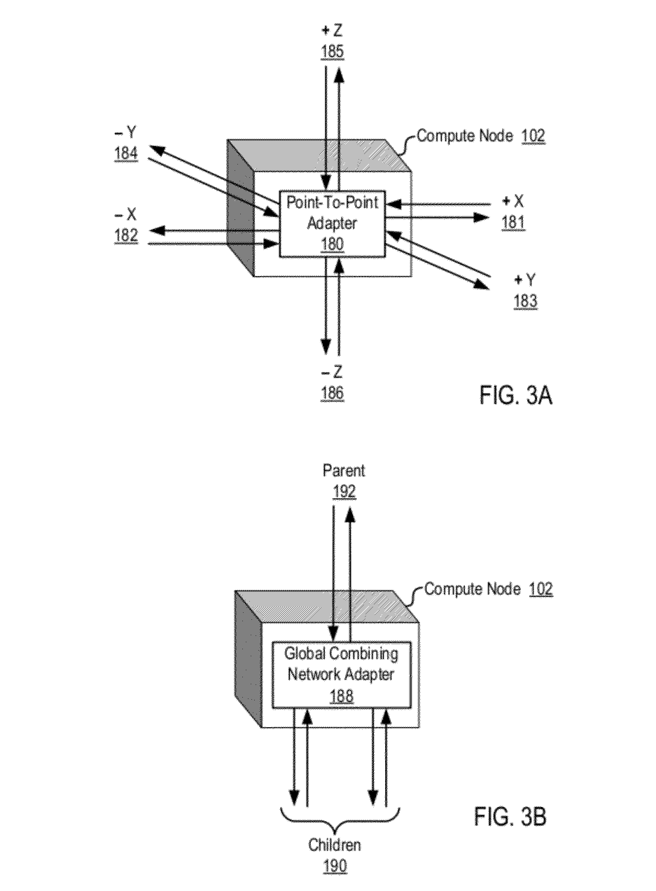

For further explanation, FIG. 3A sets forth a block diagram of an example Point-To-Point Adapter (180) useful in optimizing the deployment of a workload on a distributed processing system according to embodiments of the present invention. The Point-To-Point Adapter (180) is designed for use in a data communications network optimized for point-to-point operations, a network that organizes compute nodes in a three-dimensional torus or mesh. The Point-To-Point Adapter (180) in the example of FIG. 3A provides data communication along an x-axis through four unidirectional data communications links, to and from the next node in the −x direction (182) and to and from the next node in the +x direction (181). The Point-To-Point Adapter (180) of FIG. 3A also provides data communication along a y-axis through four unidirectional data communications links, to and from the next node in the −y direction (184) and to and from the next node in the +y direction (183). The Point-To-Point Adapter (180) of FIG. 3A also provides data communication along a z-axis through four unidirectional data communications links, to and from the next node in the −z direction (186) and to and from the next node in the +z direction (185).

For further explanation, FIG. 3B sets forth a block diagram of an example Global Combining Network Adapter (188) useful in optimizing the deployment of a workload on a distributed processing system according to embodiments of the present invention. The Global Combining Network Adapter (188) is designed for use in a network optimized for collective operations, a network that organizes compute nodes of a parallel computer in a binary tree. The Global Combining Network Adapter (188) in the example of FIG. 3B provides data communication to and from children nodes of a global combining network through four unidirectional data communications links (190), and also provides data communication to and from a parent node of the global combining network through two unidirectional data communications links (192).

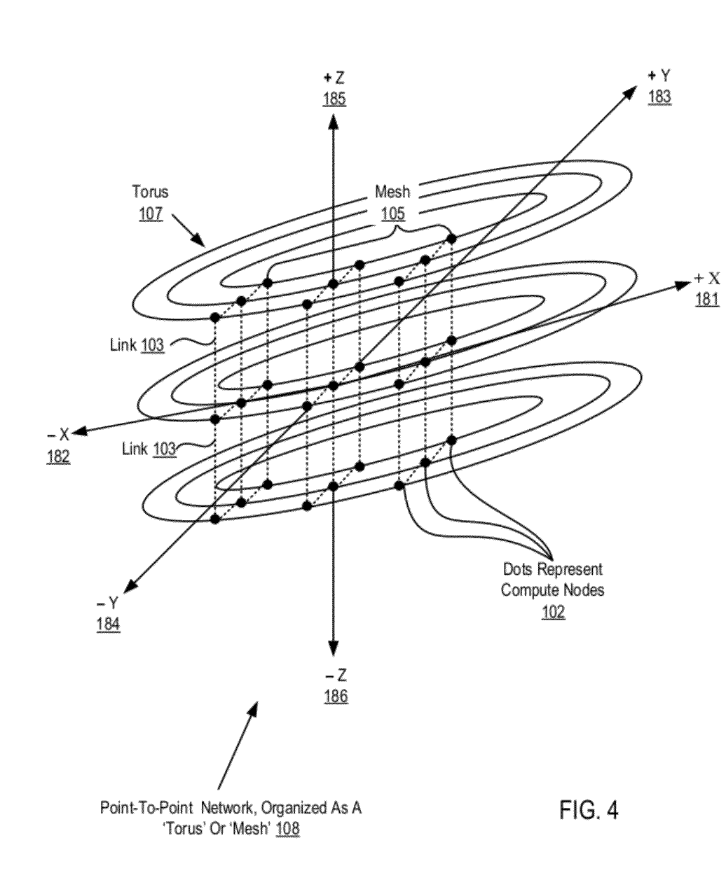

For further explanation, FIG. 4 sets forth a line drawing illustrating an example data communications network (108) optimized for optimizing the deployment of a workload on a distributed processing system according to embodiments of the present invention. In the example of FIG. 4, dots represent compute nodes (102) of a parallel computer, and the dotted lines between the dots represent data communications links (103) between compute nodes. The data communications links are implemented with point-to-point data communications adapters similar to the one illustrated for example in FIG. 3A, with data communications links on three axis, x, y, and z, and to and fro in six directions +x (181), −x (182), +y (183), −y (184), +z (185), and −z (186). The links and compute nodes are organized by this data communications network optimized for point-to-point operations into a three dimensional mesh (105). The mesh (105) has wrap-around links on each axis that connect the outermost compute nodes in the mesh (105) on opposite sides of the mesh (105). These wrap-around links form a torus (107). Each compute node in the torus has a location in the torus that is uniquely specified by a set of x, y, z coordinates. Readers will note that the wrap-around links in the y and z directions have been omitted for clarity, but are configured in a similar manner to the wrap-around link illustrated in the x direction. For clarity of explanation, the data communications network of FIG. 4 is illustrated with only 27 compute nodes, but readers will recognize that a data communications network optimized for point-to-point operations for use in optimizing the deployment of a workload on a distributed processing system in accordance with embodiments of the present invention may contain only a few compute nodes or may contain thousands of compute nodes. For ease of explanation, the data communications network of FIG. 4 is illustrated with only three dimensions, but readers will recognize that a data communications network optimized for point-to-point operations for use in optimizing the deployment of a workload on a distributed processing system in accordance with embodiments of the present invention may in facet be implemented in two dimensions, four dimensions, five dimensions, and so on. Several supercomputers now use five dimensional mesh or torus networks, including, for example, IBM's Blue Gene Q™.

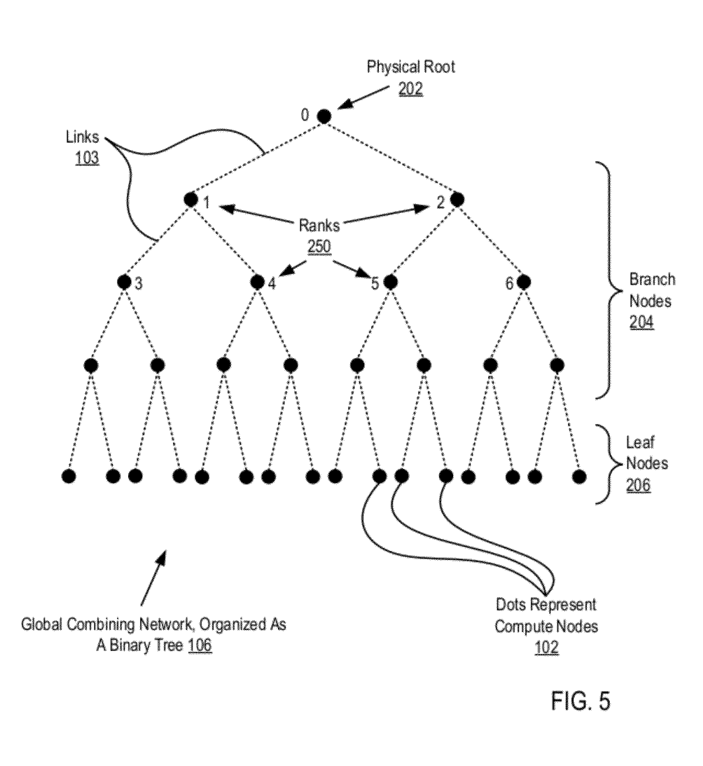

For further explanation, FIG. 5 sets forth a line drawing illustrating an example global combining network (106) useful in systems capable of optimizing the deployment of a workload on a distributed processing system according to embodiments of the present invention. The example data communications network of FIG. 5 includes data communications links (103) connected to the compute nodes so as to organize the compute nodes as a tree. In the example of FIG. 5, dots represent compute nodes (102) of a parallel computer, and the dotted lines (103) between the dots represent data communications links between compute nodes. The data communications links are implemented with global combining network adapters similar to the one illustrated for example in FIG. 3B, with each node typically providing data communications to and from two children nodes and data communications to and from a parent node, with some exceptions. Nodes in the global combining network (106) may be characterized as a physical root node (202), branch nodes (204), and leaf nodes (206). The physical root (202) has two children but no parent and is so called because the physical root node (202) is the node physically configured at the top of the binary tree. The leaf nodes (206) each has a parent, but leaf nodes have no children. The branch nodes (204) each has both a parent and two children. The links and compute nodes are thereby organized by this data communications network optimized for collective operations into a binary tree (106). For clarity of explanation, the data communications network of FIG. 5 is illustrated with only 31 compute nodes, but readers will recognize that a global combining network (106) optimized for collective operations for use in optimizing the deployment of a workload on a distributed processing system in accordance with embodiments of the present invention may contain only a few compute nodes or may contain thousands of compute nodes.

In the example of FIG. 5, each node in the tree is assigned a unit identifier referred to as a ‘rank’ (250). The rank actually identifies a task or process that is executing a parallel operation according to embodiments of the present invention. Using the rank to identify a node assumes that only one such task is executing on each node. To the extent that more than one participating task executes on a single node, the rank identifies the task as such rather than the node. A rank uniquely identifies a task's location in the tree network for use in both point-to-point and collective operations in the tree network. The ranks in this example are assigned as integers beginning with 0 assigned to the root tasks or root node (202), 1 assigned to the first node in the second layer of the tree, 2 assigned to the second node in the second layer of the tree, 3 assigned to the first node in the third layer of the tree, 4 assigned to the second node in the third layer of the tree, and so on. For ease of illustration, only the ranks of the first three layers of the tree are shown here, but all compute nodes in the tree network are assigned a unique rank.

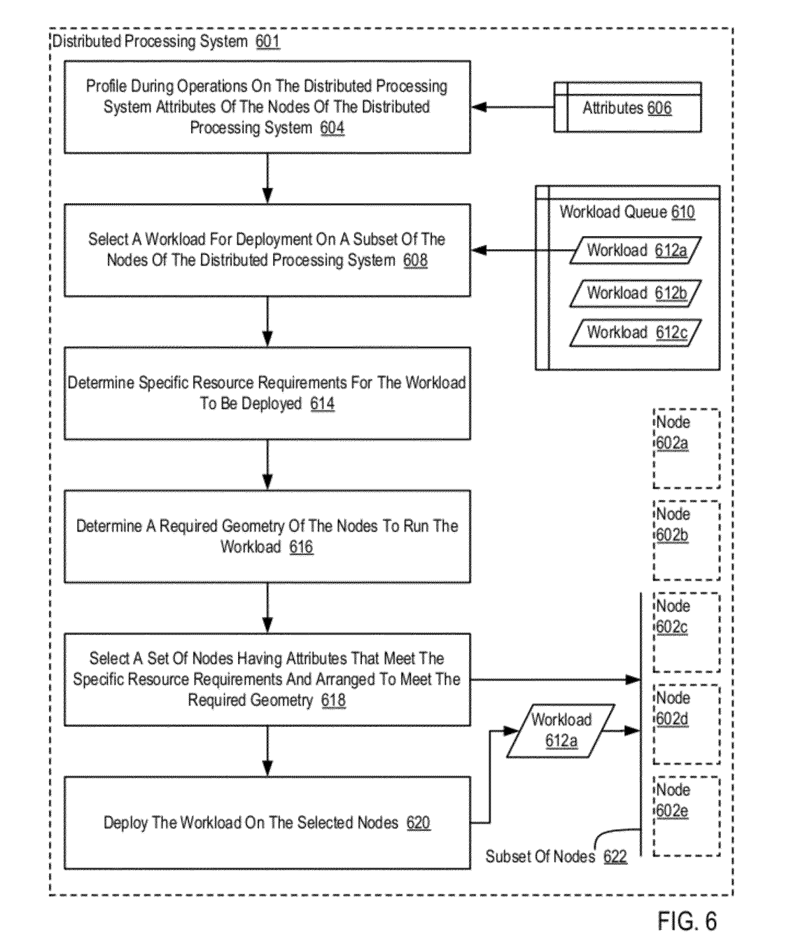

For further explanation, FIG. 6 sets forth a flow chart illustrating an exemplary method for optimizing the deployment of a workload on a distributed processing system (601) according to embodiments of the present invention. In the example of FIG. 6, the distributed processing system (601) includes a plurality of nodes (602a-602e). In the example of FIG. 6, each node (602a-602e) is characterized by a plurality of attributes (606) that describe characteristics of each node (602a-602e). For example, attributes (606) that describe characteristics of a node (602a-602e) may include, for example, the speed of a CPU on the node (602a-602e), the amount of memory on the node (602a-602e), the location of the node (602a-602e) in the distributed processing system (601), and other attributes describing the characteristics of the node (602a-602e). In addition, each node (602a-602e) may also characterized by a plurality of attributes (606) that describe characteristics of a node (602a-602e) in the sense that the attributes (606) describe performance-related characteristics of the node (602a-602e) such as, for example, the speed at which a node (602a-602e) can execute floating point operations, the speed at which a node (602a-602e) can transmit a message to another node (602a-602e), the speed at which a node can execute various I/O operations, and so on. In the example of FIG. 6, various nodes (602a-602e) of the distributed processing system (601) may have different components from one another. For example, some nodes may have local memory while other nodes do not have local memory, some nodes may have more or different processors that other nodes, some processor may have different data communications adapters than other nodes, and so on.

The example of FIG. 6 includes profiling (604) during operations on a distributed processing system (602a) attributes (606) of the nodes (602a-602e) of the distributed processing system (601). In the example of FIG. 6, profiling (604) attributes (606) of the nodes (602a-602e) may be carried out, for example, by recording performance metrics of the nodes (602a-602e). Such performance metrics may be recorded and compiled such that a profile regarding the performance attributes of the nodes (602a-602e) can be created. For example, performance metrics may be recorded and compiled such that a profile regarding the performance attributes of the nodes (602a-602e) can be created that details the amount of time a node (602a-602e) took to carry out a floating point operation, the amount of time a node (602a-602e) took to carry out an I/O operation, the amount of time a node (602a-602e) took to carry out a data communications operation, and other performance metrics can be recorded for the purposes of profiling (604) attributes (606) of the nodes (602a-602e) of the distributed processing system (601).

The example of FIG. 6 also includes selecting (608) a workload (612a) for deployment on a subset (622) of the nodes (602a-602e) of the distributed processing system (601). In the example of FIG. 6, the workload (612a) represents a series of computer program instructions that are to be executed. Workloads (612a-612c) may be characterized, for example, by the amount of processor cycles that are required to execute the workload (612a-612c), the amount of memory that is required to execute the workload (612a-612c), the amount of a particular type of operations are required to execute the workload (612a-612c), and so on. In the example of FIG. 6, a workload (612a) may be selected (608) for deployment on a subset (622) of the nodes (602a-602e) of the distributed processing system (601) based on, for example, a shortest-time-to-completion scheduling algorithm, a first-in-first-out scheduling algorithm, the availability of a particular type of system resource, a priority associated with the workload (612a), and so on. In the example of FIG. 6, workloads (612a-612c) may be stored in a workload queue (610) and removed from the workload queue (610) as each workload (612a-612c) is selected for deployment.

The example of FIG. 6 also includes determining (614) specific resource requirements for the workload (612a) to be deployed. In the example of FIG. 6, determining (614) specific resource requirements for the workload (612a) to be deployed may be carried out, for example, by examining the computer program instructions that make up the workload (612a). The computer program instructions that make up the workload (612a) may be examined to determine, for example, the number of floating point instructions in the workload (612a), the amount of data communications operations in the workload (612a), the amount of I/O operations in the workload (612a), the number of message passing operations in the workload (612a), and so on. Determining (614) specific resource requirements for the workload (612a) to be deployed may therefore be carried out by determining the nature and amount of system resources that are needed to execute each of the component parts of the workload (612a).

The example of FIG. 6 also includes determining (616) a required geometry of the nodes (602a-602e) to run the workload (612a). In the example of FIG. 6, a required geometry of the nodes (602a-602e) to run the workload (612a) may be determined (616), for example, based on the computer program instructions that make up the workload (612a). For example, a particular workload (612a) may include a collective operation as described above. In such an example, the collective operation requires that the nodes (602a-602e) are organized as a tree. The required geometry of the nodes (602a-602e) to run the workload (612a) in such an example is therefore a tree geometry. Alternatively, a particular workload (612a) may require a high number of data communications operations such that a geometry of nodes (602a-602e) in which the nodes (602a-602e) are within close physical proximity of each other may be preferred so as to avoid data communications between nodes (602a-602e) over long physical distances.

The example of FIG. 6 also includes selecting (618) a set of nodes having attributes that meet the specific resource requirements and arranged to meet the required geometry. In the example of FIG. 6, selecting (618) a set of nodes having attributes that meet the specific resource requirements and arranged to meet the required geometry may be carried out, for example, by comparing the attributes (606) of a particular set of nodes (602a-602e) to the resource requirements and required geometry for a workload (612a) to determine a best match. Determining a best match may include prioritizing specific resource requirements of the workload (612a), determining a score for a candidate set of nodes (602a-602e), and so on.

The example of FIG. 6 also includes deploying (620) the workload (612a) on the selected nodes. In the example of FIG. 6, deploying (620) the workload (612a) on the selected nodes may be carried out, for example, by sending the workload (612a), or a portion thereof, to an execution queue on the selected nodes, assigning the workload (612a) for execution on processors of the selected nodes, and so on.

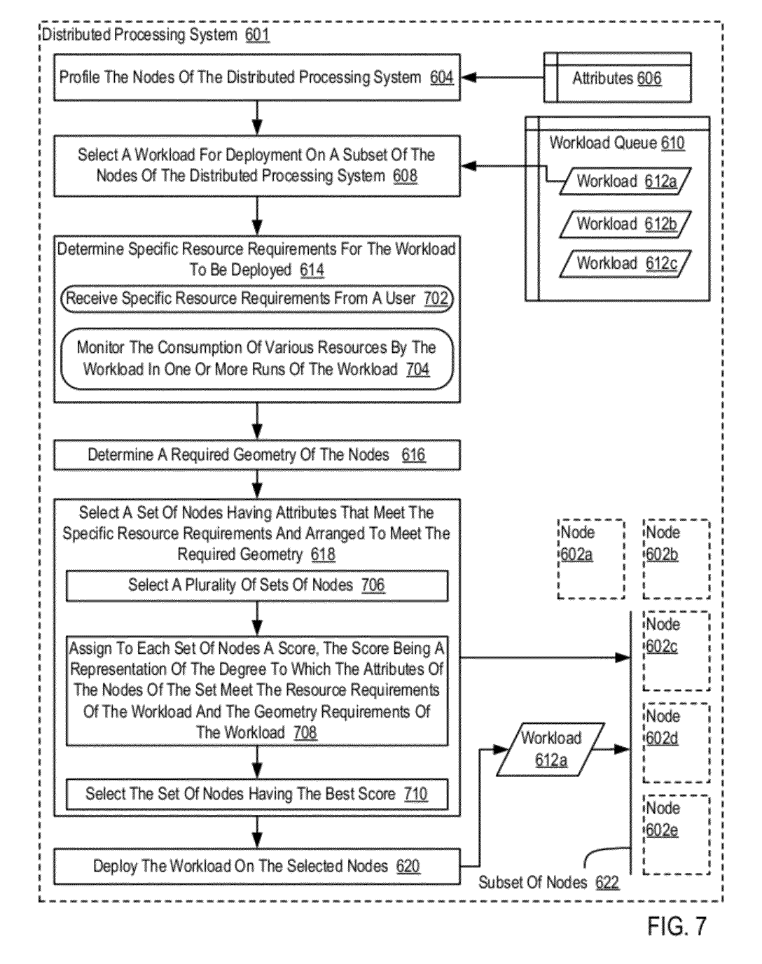

For further explanation, FIG. 7 sets forth a flow chart illustrating a further exemplary method for optimizing the deployment of a workload on a distributed processing system (601) according to embodiments of the present invention. The example of FIG. 7 is similar to the example of FIG. 6 as it also includes:
profiling (604) during operations on the distributed processing system (601) attributes (606) of the nodes (602a-602e) of the distributed processing system (601),
selecting (608) a workload (612a) for deployment on a subset (622) of the nodes (602a-602e) of the distributed processing system (601),
determining (614) specific resource requirements for the workload (612a) to be deployed,
determining (616) a required geometry of the nodes (602a-602e) to run the workload (612a),
selecting (618) a set of nodes (602a-602e) having attributes that meet the specific resource requirements and arranged to meet the required geometry, and
deploying (620) the workload (612a) on the selected nodes (602a-602e)

In the example of FIG. 7, determining (614) specific resource requirements for the workload (612a) to be deployed can include receiving (702) specific resource requirements from a user. In the example of FIG. 7, receiving (702) specific resource requirements from the user can include, for example, receiving information from a user indicating the number of nodes (602a-602e) upon which a workload (612a) should run, the amount of memory needed for executing the workload (612a), and so on. In the example of FIG. 7, receiving (702) specific resource requirements from the user can may also include receiving information from a user indicating a prioritization of system processing capabilities. For example, a user may indicate that processing I/O operations should be prioritized over data communications operations, such that nodes (602a-602e) with high I/O performance will be favored for selection over nodes that perform data communications operations efficiently.

In the example of FIG. 7, determining (614) specific resource requirements for the workload (612a) to be deployed can alternatively include monitoring (704) the consumption of various resources by the workload (612a) in one or more runs of the workload (612a). In the example of FIG. 7, monitoring (704) the consumption of various resources by the workload (612a) may include, for example, monitoring the amount of memory utilized during the execution of the workload (612a), monitoring processor usage during the execution of the workload (612a), monitoring the number of times a communications adapter was utilized during the execution of the workload (612a), and so on. Monitoring (704) the consumption of various resources by the workload (612a) in one or more runs of the workload (612a) may therefore provide information regarding the actual usage of system resources when executing the workload (612a), thereby enabling more informed decisions to be made regarding the deployment of the workload (612a).

In the example of FIG. 7, selecting (618) a set of nodes (602a-602e) having attributes that meet the specific resource requirements and arranged to meet the required geometry includes selecting (706) a plurality of candidate sets of nodes. In the example of FIG. 7, selecting (706) a plurality of sets of nodes (602a-602e) provides a plurality of candidate sets of nodes (602a-602e) upon which a workload (612a-612c) may ultimately be deployed. In the example of FIG. 7, selecting (706) a plurality of sets of nodes may be carried out, for example, by including every possible permutation of node sets in the candidate sets of nodes, by including only sets of nodes with particular attributes in the candidate sets of nodes, and so on.

In the example of FIG. 7, selecting (618) a set of nodes (602a-602e) having attributes that meet the specific resource requirements and arranged to meet the required geometry also includes assigning (708) to each candidate set of nodes a score, the score being a representation of the degree to which the attributes of the nodes of the candidate set meet the resource requirements of the workload (612a) and the geometry requirements of the workload (612a). In the example of FIG. 7, each score may be calculated in a variety of ways. For example, each score may be calculated as a percentage of the specific resource requirements that are satisfied by a particular candidate set of nodes, as a weighted score in which particular resource requirements of high importance are given a higher value than particular resource requirements of high importance, and so on. In the example of FIG. 7, selecting (618) a set of nodes (602a-602e) having attributes that meet the specific resource requirements and arranged to meet the required geometry may therefore include selecting (710) the set of nodes having the best score.

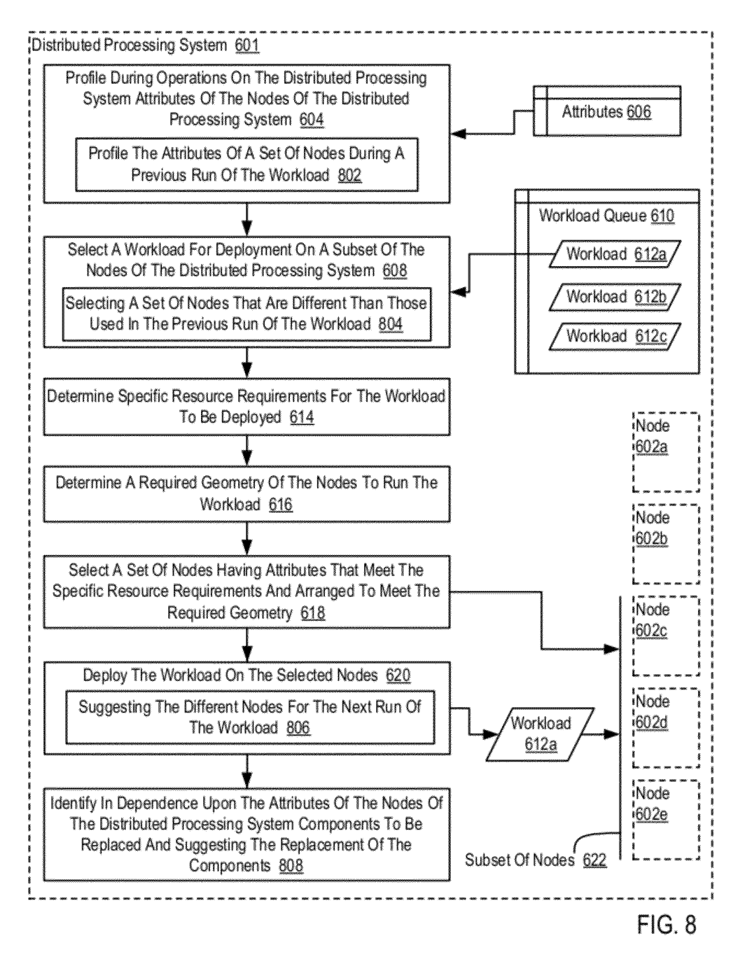

For further explanation, FIG. 8 sets forth a flow chart illustrating a further exemplary method for optimizing the deployment of a workload on a distributed processing system (601) according to embodiments of the present invention. The example of FIG. 8 is similar to the example of FIG. 6 as it also includes:
profiling (604) during operations on the distributed processing system (601) attributes (606) of the nodes (602a-602e) of the distributed processing system (601),
selecting (608) a workload (612a) for deployment on a subset (622) of the nodes (602a-602e) of the distributed processing system (601),
determining (614) specific resource requirements for the workload (612a) to be deployed,
determining (616) a required geometry of the nodes (602a-602e) to run the workload (612a),
selecting (618) a set of nodes (602a-602e) having attributes that meet the specific resource requirements and arranged to meet the required geometry, and
deploying (620) the workload (612a) on the selected nodes (602a-602e)

In the example of FIG. 8, profiling (604) during operations on the distributed processing system (601) attributes (606) of the nodes (602a-602e) of the distributed processing system (601) includes profiling (802) the attributes of a set of nodes during a previous run of the workload (612a). As described above with reference to FIG. 6, profiling (604) attributes (606) of the nodes (602a-602e) may be carried out, for example, by recording performance metrics of the nodes (602a-602e). For example, performance metrics may be recorded and compiled such that a profile regarding the performance attributes of the nodes (602a-602e) can be created that details the amount of time a node (602a-602e) took to carry out a floating point operation, the amount of time a node (602a-602e) took to carry out an I/O operation, the amount of time a node (602a-602e) took to carry out a data communications operation, and so on. In the example of FIG. 8, however, profiling (604) during operations on the distributed processing system (601) attributes (606) of the nodes (602a-602e) of the distributed processing system (601) includes profiling (802) the attributes of a set of nodes during a previous run of the workload (612a). That is, the workload (612a) may be executed and performance metrics may be recorded while the workload (612a) is being executed. These recorded performance metrics may be used at a later time such that profiling (604) attributes (606) of the nodes (602a-602e) takes into account the recorded performance metrics, even if the workload (612a), or other workloads (612b, 612c) have been executed in the interim.

In the example of FIG. 8, selecting (608) a workload (612a) for deployment on a subset (622) of the nodes (602a-602e) of the distributed processing system (601) includes selecting (804) a set of nodes that are different than those used in the previous run of the workload (612a). In the example of FIG. 8, profiling (802) the attributes of a set of nodes during a previous run of the workload (612a) can include recording information identifying the particular set of nodes that executed the workload (612a) during the previous run. In such an example, selecting (608) a workload (612a) for deployment on a subset (622) of the nodes (602a-602e) of the distributed processing system (601) can include selecting some combination of nodes other than the combination of nodes that executed the workload (612a) during the previous run.

In the example of FIG. 8, deploying (620) the workload (612a) on the selected nodes (602a-602e) includes suggesting (806) the set of nodes that are different than those used in the previous run of the workload (612a) for the next run of the workload (612a). In the example of FIG. 8, suggesting (806) the set of nodes that are different than those used in the previous run of the workload (612a) for the next run of the workload (612a) may be carried out, for example, by delivering a prompt to the user suggesting the set of nodes that are different than those used in the previous run of the workload (612a). In such an example, the user may choose, via the prompt, to use the set of nodes that are different than those used in the previous run of the workload (612a) for the next run of the workload (612a).

The example of FIG. 8 also includes identifying (808) in dependence upon the attributes of the nodes (602a-602e) of the distributed processing system (601), components to be replaced and suggesting the replacement of the components. In the example of FIG. 8, identifying (808) components to be replaced may be carried out, for example, by identifying nodes (602a-602e) that are malfunctioning, by identifying nodes (602a-602e) with attributes that are low priority attributes for executing a particular workload (612a-612c), and so on. In the example of FIG. 8, suggesting the replacement of the components may be carried out, for example, by delivering a prompt to a user such as a system administrator that identifies the component to be replaced and suggests a replacement component that is more fit for executing a particular workload (612a-612c).

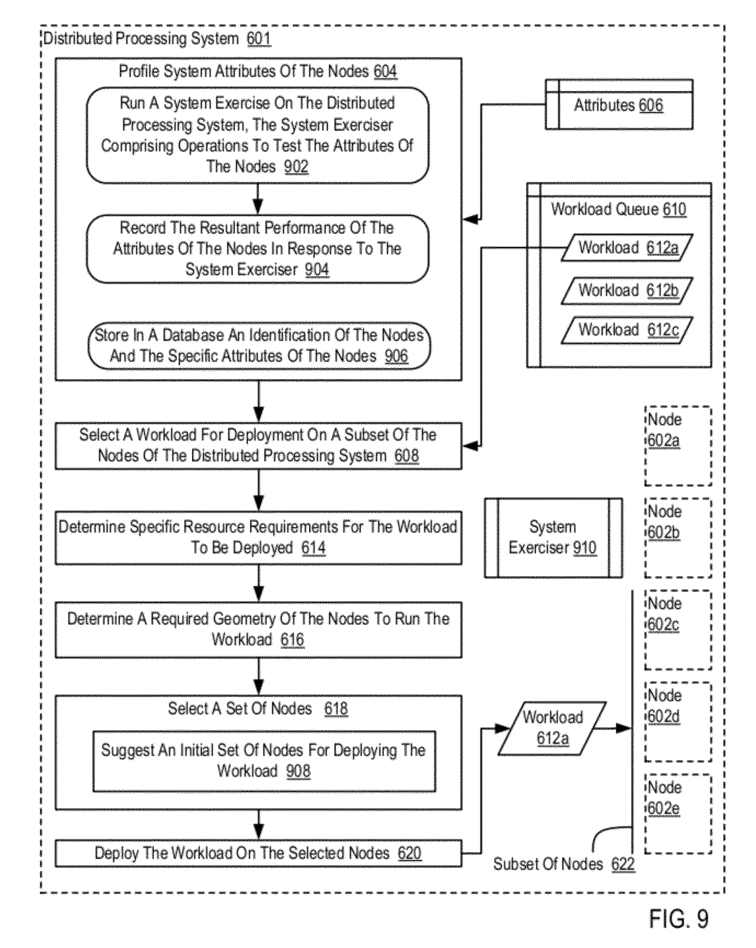

For further explanation, FIG. 9 sets forth a flow chart illustrating a further exemplary method for optimizing the deployment of a workload on a distributed processing system (601) according to embodiments of the present invention. The example of FIG. 9 is similar to the example of FIG. 6 as it also includes:
profiling (604) during operations on the distributed processing system (601) attributes (606) of the nodes (602a-602e) of the distributed processing system (601),
selecting (608) a workload (612a) for deployment on a subset (622) of the nodes (602a-602e) of the distributed processing system (601),
determining (614) specific resource requirements for the workload (612a) to be deployed,
determining (616) a required geometry of the nodes (602a-602e) to run the workload (612a),
selecting (618) a set of nodes (602a-602e) having attributes that meet the specific resource requirements and arranged to meet the required geometry, and
deploying (620) the workload (612a) on the selected nodes (602a-602e)

In the example of FIG. 9, profiling (604) during operations on the distributed processing system (601) attributes (606) of the nodes (602a-602e) of the distributed processing system (601) may include running (902) a system exerciser (910) on the distributed processing system (601). In the example of FIG. 9, the system exerciser (910) includes operations to test the attributes of the nodes (602a-602e). In the example of FIG. 9, the system exerciser (910) may be embodied as automated computing machinery such as a module of computer program instructions executing on computer hardware. The system exerciser (910) may include various operations, embodied as computer program instructions, which test the attributes of the nodes (602a-602e). The system exerciser (910) may test the attributes of the nodes (602a-602e), for example, by executing floating point operations, data communications operations, memory access operations, and the like to determine how quickly each of the nodes (602a-602e) may carry out the operations such that a processing profile may be compiled for each of the nodes (602a-602e).

In the example of FIG. 9, profiling (604) during operations on the distributed processing system (601) attributes (606) of the nodes (602a-602e) of the distributed processing system (601) may also include recording (904) the resultant performance of the attributes of the nodes (602a-602e) in response to the system exerciser (910). In the example of FIG. 9, recording (904) the resultant performance of the attributes of the nodes (602a-602e) in response to the system exerciser (910) may be carried out, for example, by recording (904) the resultant performance of the attributes of the nodes (602a-602e) in a special purpose node attribute table that includes measured performance metrics for each of the nodes (602a-602e).

In the example of FIG. 9, selecting (618) a set of nodes (602a-602e) having attributes that meet the specific resource requirements and arranged to meet the required geometry includes suggesting (908) an initial set of nodes for deploying the workload (612a). In the example of FIG. 9, suggesting (908) an initial set of nodes for deploying the workload (612a) may be carried out, for example, by sending a prompt to a user such as a system administrator, by simply deploying the selected (618) set of nodes (602a-602e), and so on.

In the example of FIG. 9, profiling (604) during operations on the distributed processing system (601) attributes (606) of the nodes (602a-602e) of the distributed processing system (601) may include storing (906) in a database an identification of the nodes and the specific attributes of the nodes. Storing (906) an identification of the nodes and the specific attributes of the nodes in a database may be carried out, for example, by writing the attributes of the nodes to the database upon completion of a workload (612a-612c), by writing the attributes of the nodes to the database at predetermined intervals such as a predetermined interval of time or a predetermined number of workload executions, by writing the attributes of the nodes to the database when total system utilization drops below a predetermined threshold, and so on.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of optimizing the deployment of a workload on a distributed processing system, the distributed processing system having a plurality of nodes, each node having a plurality of attributes, the method comprising:
profiling during operations on the distributed processing system attributes of the nodes of the distributed processing system;
selecting a workload for deployment on a subset of the nodes of the distributed processing system;
determining specific resource requirements for the workload to be deployed;
determining a required geometry of the nodes to run the workload;
selecting a set of nodes having attributes that meet the specific resource requirements and arranged to meet the required geometry; and
deploying the workload on the selected nodes.

2. The method of claim 1 wherein selecting a set of nodes having attributes that meet the specific resource requirements and arranged to meet the required geometry further comprises:
selecting a plurality of candidate sets of nodes;
assigning to each candidate set of nodes a score, the score being a representation of the degree to which the attributes of the nodes of the set meet the resource requirements of the workload and the geometry requirements of the workload; and
selecting the candidate set of nodes having the best score.

3. The method of claim 1 wherein profiling during operations on the distributed processing system attributes of the nodes of the distributed processing system comprises profiling the attributes of a set of nodes during a previous run of the workload; and
selecting a set of nodes having attributes that meet the specific resource requirements and arranged to meet the required geometry further comprises selecting a set of nodes that are different than those used in the previous run of the workload; and
deploying the workload on the selected nodes further comprises suggesting the set of nodes that are different than those used in the previous run of the workload for the next run of the workload.

4. The method of claim 1 wherein profiling during operations on the distributed processing system attributes of the nodes of the distributed processing system further comprises:
running a system exerciser on the distributed processing system, the system exerciser comprising operations to test the attributes of the nodes; and
recording the resultant performance of the attributes of the nodes in response to the system exerciser; and
selecting a set of nodes having attributes that meet the specific resource requirements and arranged to meet the required geometry further comprises suggesting an initial set of nodes for deploying the workload.

5. The method of claim 1 wherein determining specific resource requirements for the workload to be deployed further comprises receiving specific resource requirements from the user.

6. The method of claim 1 wherein determining specific resource requirements for the workload to be deployed further comprises monitoring the consumption of various resources by the workload in one or more runs of the workload.

7. The method of claim 1 wherein profiling during operations on the distributed processing system attributes of the nodes of the distributed processing system further comprises storing in a database an identification of the nodes and the specific attributes of the nodes.

8. The method of claim 1 wherein various nodes of the distributed processing system have different components from one another.

9. The method of claim 1 further comprising identifying in dependence upon the attributes of the nodes of the distributed processing system components to be replaced and suggesting the replacement of the components.

10. Apparatus for optimizing the deployment of a workload on a distributed processing system, the apparatus comprising a computer processor, a computer memory operatively coupled to the computer processor, the computer memory having disposed within it computer program instructions that, when executed by the computer processor, cause the apparatus to carry out the steps of:
profiling during operations on the distributed processing system attributes of the nodes of the distributed processing system;
selecting a workload for deployment on a subset of the nodes of the distributed processing system;
determining specific resource requirements for the workload to be deployed;
determining a required geometry of the nodes to run the workload;
selecting a set of nodes having attributes that meet the specific resource requirements and arranged to meet the required geometry; and
deploying the workload on the selected nodes.

11. The apparatus of claim 10 wherein selecting a set of nodes having attributes that meet the specific resource requirements and arranged to meet the required geometry further comprises:
selecting a plurality of candidate sets of nodes;
assigning to each candidate set of nodes a score, the score being a representation of the degree to which the attributes of the nodes of the set meet the resource requirements of the workload and the geometry requirements of the workload; and
selecting the candidate set of nodes having the best score.

12. The apparatus of claim 10 wherein profiling during operations on the distributed processing system attributes of the nodes of the distributed processing system comprises profiling the attributes of a set of nodes during a previous run of the workload; and
selecting a set of nodes having attributes that meet the specific resource requirements and arranged to meet the required geometry further comprises selecting a set of nodes that are different than those used in the previous run of the workload; and
deploying the workload on the selected nodes further comprises suggesting the set of nodes that are different than those used in the previous run of the workload for the next run of the workload.

13. The apparatus of claim 10 wherein profiling during operations on the distributed processing system attributes of the nodes of the distributed processing system further comprises:
running a system exerciser on the distributed processing system, the system exerciser comprising operations to test the attributes of the nodes; and
recording the resultant performance of the attributes of the nodes in response to the system exerciser; and
selecting a set of nodes having attributes that meet the specific resource requirements and arranged to meet the required geometry further comprises suggesting an initial set of nodes for deploying the workload.

14. The apparatus of claim 10 wherein determining specific resource requirements for the workload to be deployed further comprises receiving specific resource requirements from the user.

15. The apparatus of claim 10 wherein determining specific resource requirements for the workload to be deployed further comprises monitoring the consumption of various resources by the workload in one or more runs of the workload.

16. The apparatus of claim 10 wherein profiling during operations on the distributed processing system attributes of the nodes of the distributed processing system further comprises storing in a database an identification of the nodes and the specific attributes of the nodes.

17. The apparatus of claim 10 wherein various nodes of the distributed processing system have different components from one another.

18. The apparatus of claim 10 further comprising computer program instructions that, when executed by the computer processor, cause the apparatus to carry out the step of identifying, in dependence upon the attributes of the nodes of the distributed processing system, components to be replaced and suggesting the replacement of the components.

19. A computer program product for optimizing the deployment of a workload on a distributed processing system, the computer program product disposed upon a computer readable storage medium, the computer program product comprising computer program instructions capable, when executed, of causing a computer to carry out the steps of:
profiling during operations on the distributed processing system attributes of the nodes of the distributed processing system;
selecting a workload for deployment on a subset of the nodes of the distributed processing system;
determining specific resource requirements for the workload to be deployed;
determining a required geometry of the nodes to run the workload;
selecting a set of nodes having attributes that meet the specific resource requirements and arranged to meet the required geometry; and
deploying the workload on the selected nodes.

20. The computer program product of claim 19 wherein selecting a set of nodes having attributes that meet the specific resource requirements and arranged to meet the required geometry further comprises:
selecting a plurality of candidate sets of nodes;
assigning to each candidate set of nodes a score, the score being a representation of the degree to which the attributes of the nodes of the set meet the resource requirements of the workload and the geometry requirements of the workload; and
selecting the candidate set of nodes having the best score.

21. The computer program product of claim 19 wherein profiling during operations on the distributed processing system attributes of the nodes of the distributed processing system comprises profiling the attributes of a set of nodes during a previous run of the workload; and
selecting a set of nodes having attributes that meet the specific resource requirements and arranged to meet the required geometry further comprises selecting a set of nodes that are different than those used in the previous run of the workload; and
deploying the workload on the selected nodes further comprises suggesting the set of nodes that are different than those used in the previous run of the workload for the next run of the workload.

22. The computer program product of claim 19 wherein profiling during operations on the distributed processing system attributes of the nodes of the distributed processing system further comprises:
running a system exerciser on the distributed processing system, the system exerciser comprising operations to test the attributes of the nodes; and
recording the resultant performance of the attributes of the nodes in response to the system exerciser; and
selecting a set of nodes having attributes that meet the specific resource requirements and arranged to meet the required geometry further comprises suggesting an initial set of nodes for deploying the workload.

23. The computer program product of claim 19 wherein determining specific resource requirements for the workload to be deployed further comprises receiving specific resource requirements from the user.

24. The computer program product of claim 19 wherein determining specific resource requirements for the workload to be deployed further comprises monitoring the consumption of various resources by the workload in one or more runs of the workload.

25. The computer program product of claim 19 wherein profiling during operations on the distributed processing system attributes of the nodes of the distributed processing system further comprises storing in a database an identification of the nodes and the specific attributes of the nodes.
